(19) United States
(12) Patent Application Publication
(10) Pub. No.: US 2025/0128764 A1
(43) Pub. Date: Apr. 24, 2025

(54) VEHICLE BODY FRONT STRUCTURE

(71) Applicant: HONDA MOTOR CO., LTD., Tokyo (JP)

(72) Inventors: Keita Ishihara, Tokyo (JP); Naoki Tani, Tokyo (JP)

(21) Appl. No.: 18/916,767

(22) Filed: Oct. 16, 2024

(30) Foreign Application Priority Data
Oct. 19, 2023 (JP) 2023-180526

(51) Int. Cl. B62D 21/15; B62D 25/14; B62D 25/20

(52) U.S. Cl. CPC B62D 21/152; B62D 25/14; B62D 25/2018

(57) ABSTRACT

This vehicle body front structure includes a floor member disposed below a passenger compartment, front side frames extending forward from positions above the floor member in front of the passenger compartment, a dashboard lower panel standing forward and upward from a front part of the floor member and configured to cover the front of the passenger compartment, and a load transfer block that is an integrated casting part configured to connect rear parts of the front side frames and the front part of the floor member, the load transfer block having: a frame fixing part to which the rear parts of the front side frames are fixed, a floor fixing part to which the front part of the floor member is fixed, and a connecting wall extending substantially along the dashboard lower panel and configured to connect the frame fixing part and the floor fixing part, and a plurality of upper reinforcement ribs standing upward and extending in a forward/rearward direction being provided on an upper surface side of the connecting wall and spaced apart from each other in a vehicle width direction.

### CROSS-REFERENCE TO RELATED APPLICATION

The present application claims priority based on Japanese Patent Application No. 2023-180526, filed Oct. 19, 2023, the content of which is incorporated herein by reference.

### BACKGROUND OF THE INVENTION

### Field of the Invention

The present invention relates to a vehicle body front structure.

### Description of Related Art

In recent years, various efforts to provide access to sustainable transport systems have been gaining momentum. To achieve this, further improving traffic safety and convenience through research for improving vehicle body rigidity has been focused upon.

As a front structure of a vehicle body, there is known a structure in which a pair of front side frames are disposed on left and right sides of a vehicle front part and rear parts of the front side frames are connected to the load support member (for example, see Japanese Unexamined Patent Application, First Publication No. 2004-82932).

The vehicle body front structure disclosed in Japanese Unexamined Patent Application, First Publication No. 2004-82932 is a structure in which the front side frames can be crushed in multiple stages depending on the magnitude of the impact load input from the front. The rear parts of the left and right front side frames of the vehicle body front structure are connected to load support members that are positioned lower than the front side frames. In the vehicle body front structure, when the impact load is input from the front of the vehicle, the input load is reliably received by the load support member in the rear parts of the front side frames, ensuring the crush on the front side frames.

### SUMMARY OF THE INVENTION

However, in the vehicle body front structure disclosed in Japanese Unexamined Patent Application, First Publication No. 2004-82932, the load support member that receives the load when the impact load is input from the front is positioned offset lower than the front side frames. For this reason, when the impact load is input, a large moment tends to occur around the rear parts of the front side frames and the connection part of the load support member. Then, occurrence of this moment may hinder the smooth crush of the front side frames, and improvement in this respect is desired.

An aspect of the present invention is directed to providing a vehicle body front structure capable of rigidly receiving a load input to front side frames using rear parts of the front side frames when an impact load is input from the front, resulting in a smooth crush of the front side frames. Then, in turn, the present invention is directed to contributing to development of a sustainable transport system.

In order to accomplish the above-mentioned purposes, a vehicle body front structure according to an aspect of the present invention employs the following configurations.

(1) An aspect of the present invention includes a floor member (for example, a floor member (12) of an embodiment) disposed below a passenger compartment (for example, a passenger compartment (2) of the embodiment); front side frames (for example, front side frames (10) of the embodiment) extending forward from positions above the floor member in front of the passenger compartment; a dashboard lower panel (for example, a dashboard lower panel (13) of the embodiment) standing forward and upward from a front part of the floor member and configured to cover the front of the passenger compartment; and a load transfer block (for example, a load transfer block (11) of the embodiment) that is an integrated casting part configured to connect rear parts of the front side frames and the front part of the floor member, the load transfer block having a frame fixing part (for example, a frame fixing part (17) of the embodiment) to which the rear parts of the front side frames are fixed; a floor fixing part (for example, a floor fixing part (18) of the embodiment) to which the front part of the floor member is fixed; and a connecting wall (for example, a connecting wall (19) of the embodiment) extending substantially along the dashboard lower panel and configured to connect the frame fixing part and the floor fixing part, and a plurality of upper reinforcement ribs (for example, upper reinforcement ribs (20) of the embodiment) standing upward and extending in a forward/rearward direction being provided on an upper surface side of the connecting wall and spaced apart from each other in a vehicle width direction.

According to the aspect of the above-mentioned (1), when an impact load is input from the front of the front side frames, the load is transmitted to the floor member via the load transfer block. Here, the load input from the front side frames to the frame fixing part of the load transfer block is transmitted to the floor fixing part through the connecting wall inclined rearward as it goes downward. Here, while a compression load is applied to the upper surface side of the connecting wall, the compression load is received by the plurality of upper reinforcement ribs provided on the upper surface side of the connecting wall. The plurality of upper reinforcement ribs stand upward and extend in the forward/rearward direction, and are spaced apart from each other in the vehicle width direction. For this reason, the compression load applied to the upper surface side of the connecting wall can be efficiently received.

As a result, the front side frames to which the impact load is input from the front is rigidly supported at the rear parts by the load support block, and the extension region on the front side is smoothly crushed.

(2) In the aspect of the above-mentioned (1), a panel fixing part (for example, a panel fixing part (23) of the embodiment) fixed to the dashboard lower panel above the upper reinforcement rib may be provided on the connecting wall.

According to the aspect of the above-mentioned (2), the panel fixing part of the connecting wall is fixed to the dashboard lower panel at a position above the upper reinforcement rib of the connecting wall. For this reason, when the impact load is input, some of the load is received by the dashboard lower panel. Accordingly, the impact load transmitted to the connecting wall of the load transfer block is distributed to a route passing through the panel fixing part and a route passing through the floor fixing part to be transmitted to the load support member of the passenger compartment front part. Accordingly, when the configuration is employed, it is possible to prevent the load from concentrating at a fixed point of the floor fixing part.

(3) In the aspect of the above-mentioned (1) or (2), an upper extension rib (for example, an upper extension rib (26) of the embodiment) continuous with the upper reinforcement rib may be provided on the upper surface of the floor fixing part, a lower rib (for example, a lower rib (27) of the embodiment) having rib elements (for example, rib elements (27a) of the embodiment) protruding downward and extending in multiple directions may be provided on a lower surface of the floor fixing part, and a protrusion height of the upper extension rib may be set to be greater than a protrusion height of the lower rib.

According to the aspect of the above-mentioned (3), when the impact load is input from the front, a compression load applied to the connecting part of the connecting wall and the floor fixing part can be reliably received by the upper extension rib of the floor fixing part. In addition, in this configuration, the protrusion height of the upper extension rib to which the compression load is applied is greater than the protrusion height of the lower rib to which a tensile load is applied. For this reason, when the configuration is employed, deformation or bending of the connecting wall and the floor fixing part can be efficiently regulated, and further, the substantial thickness of the lower rib having the plurality of rib elements extending in multiple directions can be reduced.

(4) In the aspect of the above-mentioned (3), the lower rib disposed in a region adjacent to an end portion of the floor fixing part in the vehicle width direction may be set such that an extension direction of the rib element does not face the vehicle width direction.

According to the aspect of the above-mentioned (4), in the region where the rib elements do not face the vehicle width direction, when the impact load is input in the vehicle width direction, that part is easily deformed in the vehicle width direction. For this reason, when the impact load is input from the side of the vehicle, the outer region of the floor fixing part in the vehicle width direction can be smoothly deformed to efficiently absorb an input impact.

According to the aspect of the present invention, the plurality of upper reinforcement ribs standing upward and extending in the forward/rearward direction are provided on the upper surface side of the connecting wall of the load transfer block and spaced apart from each other in the vehicle width direction. For this reason, when the impact load is input from the front of the front side frames, the compression load applied to the upper surface side of the connecting wall of the load transfer block can be efficiently received by the plurality of upper reinforcement ribs. Accordingly, in the case in which the vehicle body front structure according to the present invention is employed, when the impact load is input from the front, the load input to the front side frames can be rigidly received by the rear parts of the front side frames, and the front side frames can be smoothly crushed. Accordingly, energy of the input impact load can be efficiently absorbed by the smooth crush of the front side frames.

### BRIEF DESCRIPTION OF THE DRAWINGS

FIG. 1 is a perspective view of a front part of a vehicle of an embodiment.

FIG. 2 is a side view of the front part of the vehicle of the embodiment.

FIG. 3 is a perspective view when a load transfer block of the embodiment is seen from above a rear part.

FIG. 4 is a cross-sectional view of the front part of the vehicle corresponding to a cross section along line IV-IV in FIG. 3.

FIG. 5 is a bottom view of the load transfer block of the embodiment.

FIG. 6 is a perspective view showing the load transfer block of the embodiment when seen from below.

FIG. 7 is a cross-sectional view when seen by cutting the load transfer block at a position slightly offset in a vehicle width direction with respect to the cross section of FIG. 4.

### DESCRIPTION OF EMBODIMENTS

Hereinafter, an embodiment of the present invention will be described with reference to the accompanying drawings. Further, in appropriate places of the drawings, an arrow FR indicates a forward direction in a vehicle, an arrow UP indicates an upward direction of the vehicle, and an arrow LH indicates a leftward direction of the vehicle (a leftward side when the vehicle is directed forward).

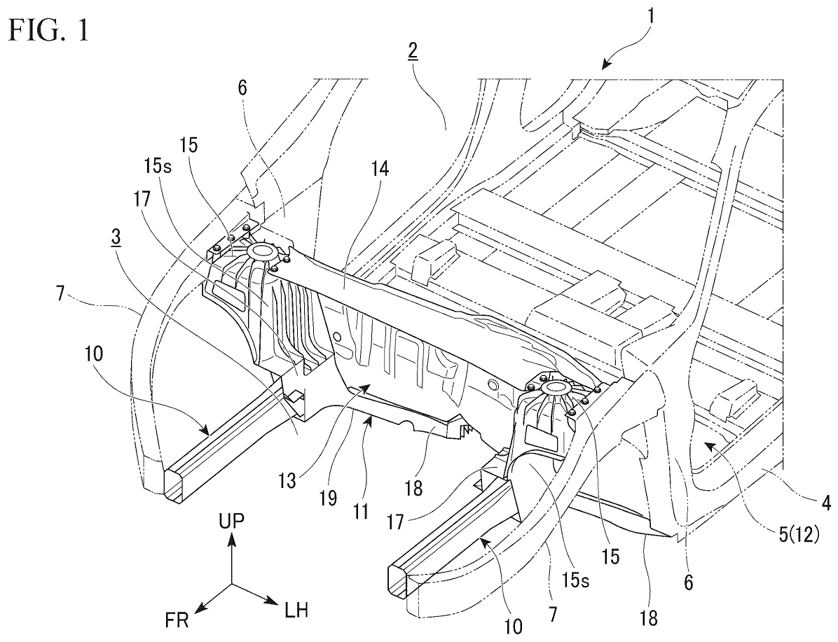

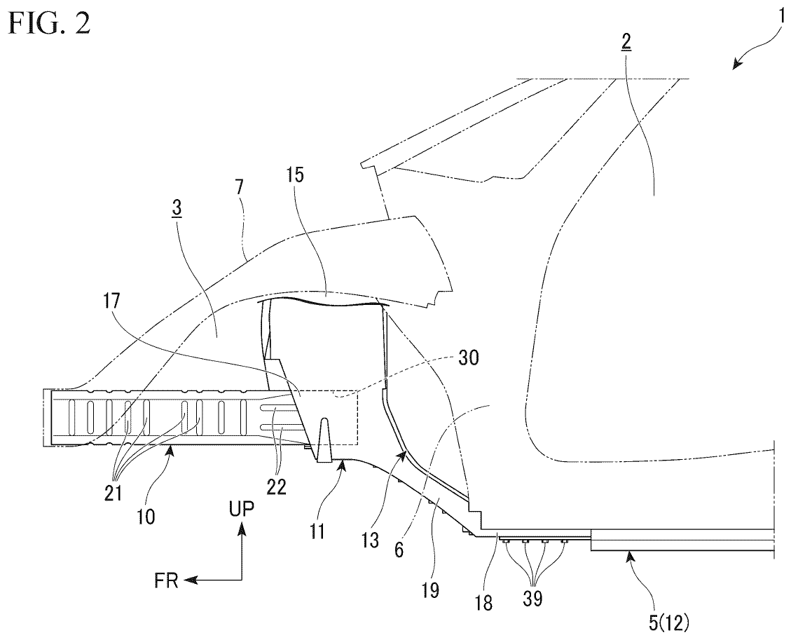

FIG. 1 is a perspective view of a front part of a vehicle 1 of the embodiment, and FIG. 2 is a side view of the front part of the vehicle 1 when seen from a left side.

Reference sign 2 in FIG. 1 and FIG. 2 designates a passenger compartment in which an occupant rides, and reference sign 3 designates a front compartment in front of the passenger compartment 2 and in which a driving motor, an engine, or the like, is accommodated. Front side frames 10 extending substantially in a vehicle body forward/rearward direction are disposed on both sides of the front compartment 3 in a vehicle width direction. Rear end portions of the left and right front side frames 10 are connected to a frame member of a front part of the passenger compartment 2 via a load transfer block 11, which will be described below in detail.

Side sills 4 extending substantially in the vehicle body forward/rearward direction are disposed on left and right side portions of a lower side of the passenger compartment 2. A floor panel 5 disposed below the passenger compartment 2 is installed across the left and right side sills 4. The floor panel 5 is reinforced by a plurality of reinforcement frames (not shown) extending in a forward/rearward direction and a widthwise direction of the vehicle body.

In the embodiment, the floor panel 5 and these reinforcement frames are collectively referred to as a floor member 12. Further, the left and right front side frames 10 extend forward from positions above the floor member 12.

A space between the front part of the passenger compartment 2 and the front compartment 3 is partitioned by a dashboard lower panel 13. The dashboard lower panel 13 has a lower end connected to a front edge portion of the floor member 12, and stands up to be inclined forward and upward from the front part of the floor member 12. An upper portion of the dashboard lower panel 13 is connected to a cowl top panel 14 or the other frame members.

Front pillars 6 that constitute a front edge of a door opening on the front side are connected to front end portions of the left and right side sills 4. Upper members 7 extending substantially in the vehicle body forward/rearward direction are connected to front surface sides of the upper portions of the front pillars 6 at outer positions of the front compartment 3 in the vehicle width direction. The upper members 7 are curved from the left and right front pillars 6 toward below the front part of the vehicle body, and front end portions thereof extend to positions outside the front end portions of the front side frames 10. The front end portions of the upper members 7 are connected to the front end portions of the front side frames 10 corresponding to left and right sides via a connecting member (not shown).

Damper housing parts 15 of left and right upper portions of the load transfer block 11, which will be described below in detail, are connected to base parts (rear regions) of the left and right upper members 7. The damper housing parts 15 support upper portions of dampers of front suspensions (not shown).

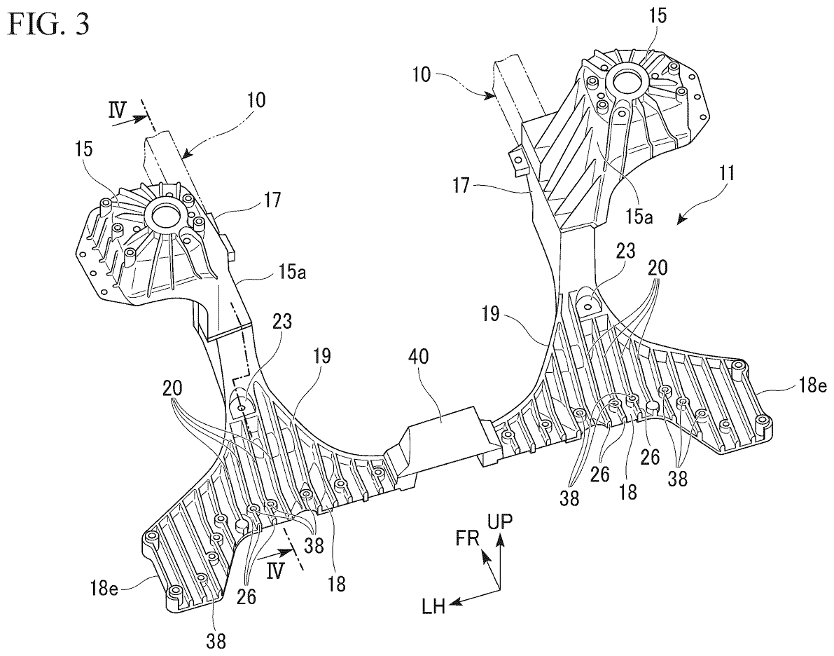

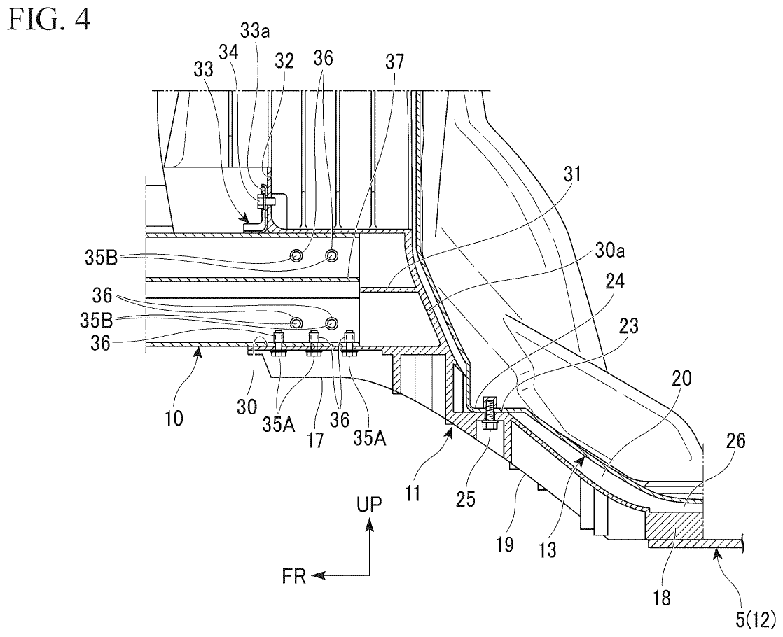

FIG. 3 is a perspective view showing the load transfer block 11 when seen from above the rear part. In addition, FIG. 4 is a cross-sectional view of the front part of the vehicle corresponding to the cross section along line IV-IV in FIG. 3.

The left and right front side frames 10 fixed to the load transfer block 11 are formed in a square tubular (rectangular tubular) frame shape as shown in FIG. 1 and FIG. 4. The rear end portions of the front side frames 10 are inserted into a frame fixing part 17 of the load transfer block 11 described below, and in this state, are fixed to the frame fixing part 17 by a plurality of bolts 35A and 35B (fastening members). The front side frames 10 are formed of for example, aluminum, ferrous metals, or the like.

The front side frames 10 are frame members that support driving system parts or suspension members arranged in the front compartment 3, but when an impact load is input from the front of the vehicle, they absorb the energy of the impact load by crushing in the forward/rearward direction. As shown in FIG. 2, a plurality of beads 21 extending in the upward/downward direction are provided on left and right sidewalls of the front side frames 10. The plurality of beads 21 are spaced apart and arranged in the forward/rearward directions on the sidewalls of the front side frames 10. The plurality of beads 21 promotes bellows-like crush deformation of the front side frames 10 when an impact load is input.

The beads 21 extending in the upward/downward direction are provided only from intermediate regions to front regions of the sidewalls of the front side frames 10 in the forward/rearward direction. A plurality of beads 22 extending in the forward/rearward direction are provided on rear regions of the sidewalls of the front side frames 10. The beads 22 extending in the forward/rearward direction of the front side frames 10 restrict deformation of the rear region at the beginning of the crush when the impact load is input.

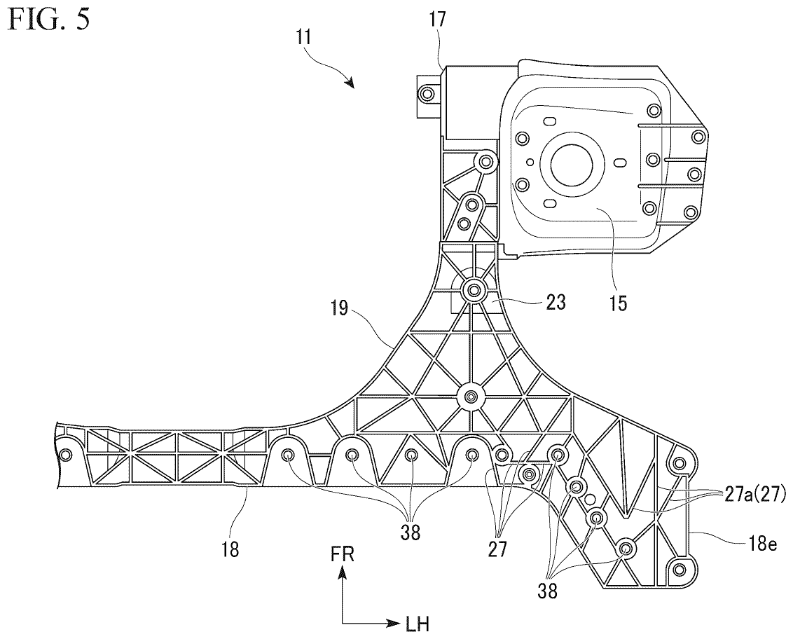

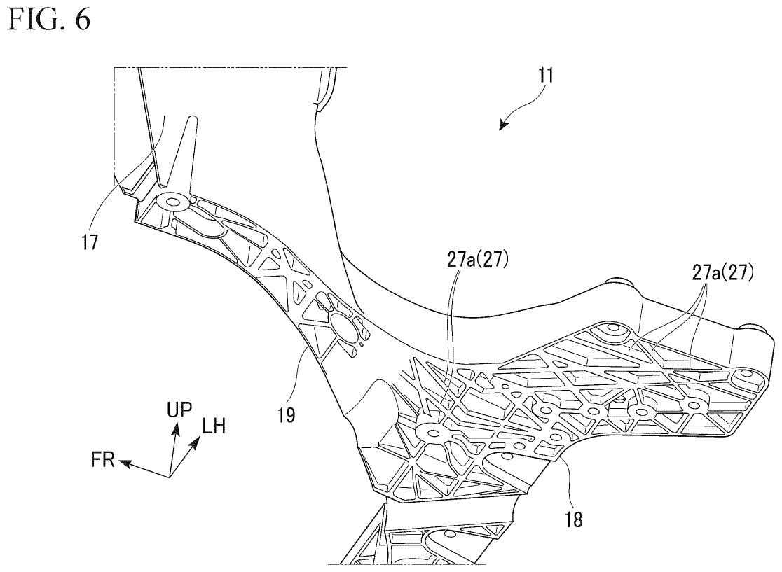

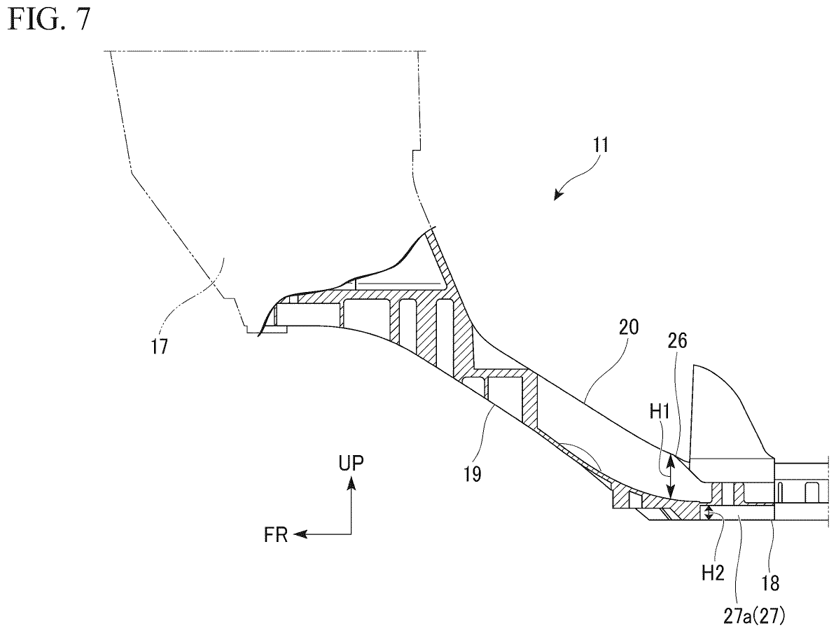

FIG. 5 is a bottom view of a left half region of the load transfer block 11. FIG. 6 is a perspective view of the left half region of the load transfer block 11 when seen from the front and below. In addition, FIG. 7 is a cross-sectional view when seen by cutting the load transfer block 11 at a position slightly offset in a vehicle width direction with respect to the cross section of FIG. 4.

As shown in FIG. 3, the load transfer block 11 is formed laterally symmetrically. The load transfer block 11 is provided with the damper housing parts 15, the frame fixing part 17, a connecting wall 19, and a floor fixing part 18 in each of the left and right regions. The load transfer block 11 containing these elements is integrally cast from, for example, aluminum. That is, the load transfer block 11 is an integral casting part that has the above components.

As mentioned above, the damper housing parts 15 are portions that support the upper portion of the damper of the front suspension, and as shown in FIG. 1, are disposed above the front side frames 10 and at positions outside the front side frames 10 in the vehicle width direction. The damper housing parts 15 are formed in a downward bowl shape (a downward bottomed cylindrical shape), and the damper is disposed on the lower side (inside) of the bowl-shaped part. The damper housing parts 15 support the upper portion of the damper of the front suspension at its apex portion.

The damper housing parts 15 are connected to the base parts of the upper members 7 corresponding on the left and right sides as described above through bolt fastening or the like. In addition, the cowl top panel 14 is provided across the left and right damper housing parts 15 connected to the upper members 7. The left and right end portions of the cowl top panel 14 are connected to the damper housing parts 15 corresponding on the left and right sides through bolt fastening or the like.

The frame fixing part 17 is connected to lower sides of sidewalls 15s on the inner side in the vehicle width direction of the damper housing parts 15. The frame fixing part 17 is a part that fixes the rear parts of the front side frames 10, and is formed in a roughly rectangular block shape extending in the vehicle body forward/rearward direction. As shown in FIG. 4, concave portions 30 having a rectangular shape when seen in a front view, into which the rear parts of the front side frames 10 are inserted, are provided in the block portion of the frame fixing part 17. The concave portions 30 are open toward the front of the vehicle, and load receiving ribs 31 protrude from a bottom portion opposite to the opening side. The ribs 31 are load support walls that protrude from bottom walls 30a of the concave portions 30 toward the front of the vehicle, and the two rib pieces intersect to form an X shape when seen in a front view. Front end surfaces of the ribs 31 are contoured to be flat all over. The front end surfaces of the ribs 31 face rear end surfaces of the front side frames 10 with a micro gap sandwiched therebetween when the front side frames 10 are inserted into the concave portions 30.

When the rear parts of the front side frames 10 try to move backward upon input of the impact load from the front, the rear end surfaces of the front side frames 10 comes into contact with the front surfaces of the ribs 31. The front side frames 10 thereby prevent excessive retraction displacement.

In addition, a load support wall 32 continuous with upper opening edges of the concave portions 30 are provided on a front surface side of a block portion of the frame fixing part 17. The load support wall 32 is a flat wall perpendicular to the vehicle body forward/rearward direction and stands vertically upward from the upper opening edge of the concave portions 30.

A bracket 33, which is roughly L-shaped when seen in a side view, is fixed to the upper surfaces of the front side frames 10 near the rear part by welding or the like. A standing piece 33a of the bracket 33 is abutted against the front surface of the load support wall 32 of the frame fixing part 17 and is fixed in this state to the load support wall 32 by a bolt 34 (fastening member). The bolt 34 has a shaft portion that extends in the vehicle body forward/rearward direction to be tightened into the load support wall 32, thereby regulating the displacement of the front side frames 10 in the vehicle body forward/rearward direction.

In addition, the rear parts of the front side frames 10 inserted into the concave portions 30 of the frame fixing part 17 are fastened and fixed to the lower wall and one of the sidewalls of the concave portions 30 by the plurality of bolts 35A and 35B (fastening members). The bolt 35A passes through the lower walls of the concave portions 30 and is fastened to a tubular nut 36 protruding from the upper surface of the lower wall and formed of a ferrous metal. Similarly, the bolt 35B passes through the sidewalls of the concave portions 30 and is fastened to the tubular nut 36 protruding from the inner surface of the sidewall and formed of a ferrous metal.

Reinforcement walls 37 (bulkhead) that extend in the horizontal direction and connect left and right sidewalls of the front side frames 10 are provided in the rear regions of the front side frames 10. The reinforcement walls 37 extend from the rear end portions of the front side frames 10 to a position in front of the connection part of the front side frames 10 and the frame fixing part 17 by the bracket 33 and the bolt 34. The reinforcement walls 37 extend across the connection part of the front side frames 10 and the frame fixing part 17 by the bolts 35A and 35B and the connection part by the bracket 33 and the bolt 34 in the forward/rearward direction.

The floor fixing part 18 of the load transfer block 11 extends along the front edge portion of the floor member 12 in the vehicle width direction. The floor fixing part 18 is formed in a long plate shape with a sufficient vertical thickness. An outer portion of the floor fixing part 18 in the vehicle width direction is provided with a bulging part 18e that bulges trapezoidally toward the rear of the vehicle body. A plurality of fastening holes 38 passing in the upward/downward direction are formed substantially the entire region including the bulging part 18e of the floor fixing part 18. The fastening holes 38 pass in the upward/downward direction. A shaft portion of a bolt 39 (see FIG. 2) configured to fasten and fix the floor fixing part 18 to the floor member 12 can be inserted into each of the fastening holes 38.

In addition, a left region and a right region, which are laterally symmetrical to each other, of the load transfer block 11 are connected to each other in the floor fixing part 18 of the left region and the floor fixing part 18 of the right region. Specifically, as shown in FIG. 3, the floor fixing part 18 of the left region and the floor fixing part 18 of the right region are connected to each other by a connection block portion 40 at a substantially central position in the vehicle width direction.

The connecting wall 19 of the load transfer block 11 extends substantially along the front surface of the dashboard lower panel 13 disposed on the front part of the passenger compartment 2, and connects the frame fixing part 17 and the floor fixing part 18 there below. The connecting wall 19 is formed in a plate shape having the same sufficient thickness as the floor fixing part 18. The connecting wall 19 is smoothly connected to the floor fixing part 18 below to form a continuous plate shape.

The connecting wall 19 has an upper end portion connected to the rear lower end of the block portion of the frame fixing part 17. The connecting wall 19 widens downward in a wide-ended shape in the vehicle width direction, starting from the connecting portion with the frame fixing part 17 as the apex. That is, the connecting wall 19 is formed in an approximately isosceles triangular shape when seen in a front view. The lower end region of the connecting wall 19, which expands into a wide-ended shape, is continuous with (connected to) the floor fixing part 18.

A plurality of upper reinforcement ribs 20 standing upward in the forward/rearward direction (inclined forward/rearward direction) protrude toward the upper surface of the connecting wall 19. The plurality of upper reinforcement ribs 20 are formed on the upper surface side of the connecting wall 19 so as to be spaced apart in the vehicle width direction and parallel to each other.

In addition, as shown in FIG. 3 and FIG. 4, the upper surface of the upper region of the connecting wall 19, which is narrower in the vehicle width direction, is formed with a panel fixing part 23, which is partially recessed in a stepped shape and has a flat upper surface.

On the other hand, the dashboard lower panel 13, which is arranged facing the upper side of the rear part of the load transfer block 11, has a curved wall 24 with a substantially L-shaped cross section at a position facing the panel fixing part 23 on the connecting wall side. The curved wall 24 may be formed integrally with the dashboard lower panel 13, or may be formed as a separate part and connected to the dashboard lower panel 13. One surface of the curved wall 24 is overlapped with the upper surface of the panel fixing part 23 formed on the connecting wall of the load transfer block 11. The panel fixing part 23 is fastened and fixed to the curved wall 24 (the dashboard lower panel 13) by a bolt 25 (fastening member) in this state.

Here, as described above, the panel fixing part 23 is formed on the upper surface of the upper portion region of the connecting wall 19 which has a narrower width in the vehicle width direction, and the upper reinforcement ribs 20 extending in the forward/rearward direction are located directly below the panel fixing part 23 on the upper surface of the connecting wall 19. That is, the panel fixing part 23 is located in front of and above some of the upper reinforcement ribs 20.

As shown in FIG. 3, FIG. 4 and FIG. 7, upper extension ribs 26 continuous with the upper reinforcement ribs 20 on the connecting wall 19 are provided on the upper surface side of the floor fixing part 18. Each of the upper extension ribs 26 extends in the forward/rearward direction to be continuous with the upper reinforcement rib 20 corresponding thereto.

In addition, as shown in FIG. 5 to FIG. 7, a lower rib 27 protruding downward is provided on a lower surface side of the floor fixing part 18. The lower rib 27 has a plurality of rib elements 27a protruding downward and extending in multiple directions, with the rib elements 27a being interconnected. In addition, some of the rib elements 27a are connected to a circumferential wall portion 18a that form an outer contour of the floor fixing part 18. The rib elements 27a of the lower rib 27 are connected to other rib elements 27a and the circumferential wall portion 18a, forming a high-strength structural part that includes a truss structure, a cylindrical structure, or the like, on the lower surface side of the floor fixing part 18.

Further, the lower rib 27 is also continuously formed on the lower surface side of the connecting wall 19.

In addition, as shown in FIG. 7, a protrusion height H1 of the upper extension rib 26 provided on the upper surface side of the floor fixing part 18 is set to be higher than a height of the lower rib 27 provided on the lower surface side of the floor fixing part 18.

In addition, as shown in FIG. 5, the lower rib 27 disposed in a region adjacent to the side end portion of the floor fixing part 18 is set such that the rib elements 27a do not face the vehicle width direction.

### Effects of Embodiment

As described above, the vehicle body front structure of the embodiment includes the load transfer block 11, which is an integral casting part, having the frame fixing part 17, the floor fixing part 18, and the connecting wall 19. Then, the plurality of upper reinforcement ribs 20 standing upward and extending in the forward/rearward direction are spaced apart from each other in the vehicle width direction on the upper surface side of the connecting wall 19 extending substantially along the dashboard lower panel 13 and connecting the frame fixing part 17 and the floor fixing part 18. For this reason, when the impact load is input from the front side of the front side frames 10, the compression load acting on the upper surface side of the connecting wall 19 of the load transfer block 11 can be efficiently received by the plurality of upper reinforcement ribs 20. Accordingly, the movement of the front side frames 10 due to the moment acting on the front side frames 10 as a result of the input of the impact load can be suppressed by the load transfer block 11 and the floor member 12. As a result, the rear sides of the front side frames 10 are rigidly supported by the load transfer block 11, and the extension region of the front sides of the front side frames 10 can be smoothly crushed.

Accordingly, when the vehicle body front structure of the embodiment is employed, energy of the input impact load can be efficiently absorbed by the smooth crush of the front side frames 10.

In particular, in the vehicle body front structure of the embodiment, the damper housing parts 15 are integrally formed with the upper portion of the frame fixing part 17 of the load transfer block 11, and the damper housing parts 15 are connected to the upper members 7 that are frame members of the vehicle body side portions. For this reason, when the impact load is input from the front of the vehicle, the displacement of the rear parts of the front side frames 10 can be more rigidly suppressed. Accordingly, if the configuration is employed, the extension regions of the front side frames 10 can be more smoothly crushed when the impact load is input from the front of the vehicle.

In addition, in the embodiment, since the damper housing parts 15 are integrally formed with the load transfer block 11, the number of parts of the components of the vehicle can be reduced in comparison with the case in which a damper housing is provided as a separate part, and it is possible to achieve reduction in product costs and ease of assembly.

In addition, in the vehicle body front structure of the embodiment, the panel fixing part 23 fixed to the dashboard lower panel 13 above the upper reinforcement ribs 20 are provided on the connecting wall 19 of the load transfer block 11. For this reason, when the impact load is input from the front, some of the load can be received by the dashboard lower panel 13 at the position above the upper reinforcement ribs 20. As a result, the impact load transmitted to the connecting wall 19 of the load transfer block 11 is distributed into a route passing through the panel fixing part 23 and a route passing through the floor fixing part 18 to be transmitted to the load support member of the passenger compartment front part. Accordingly, when the configuration is employed, it is possible to prevent the load from concentrating on a fixed point of the floor fixing part 18.

In addition, in the vehicle body front structure of the embodiment, the upper extension rib 26 continuous with the upper reinforcement ribs 20 is provided on the upper surface side of the floor fixing part 18 of the load transfer block 11, and the lower rib 27 is provided on the lower surface side of the floor fixing part 18. Then, the lower rib 27 has a structure in which the rib elements 27a protruding downward extend in multiple directions. For this reason, when the impact load is input from the front, the compression load applied to the connecting part of the connecting wall 19 and the floor fixing part 18 can be reliably received by the upper extension rib 26 of the floor fixing part 18. In addition, rigidity of the floor fixing part 18 in various directions can be increased by the lower rib 27.

Further, in the embodiment, the protrusion height of the upper extension rib 26 is set to be greater than the protrusion height of the lower rib 27. For this reason, deformation or bending of the connecting wall 19 and the floor fixing part 18 can be efficiently regulated by the upper extension rib 26 when the impact load is input from the front, and furthermore, the substantial thickness of the lower rib 27 from which the plurality of rib elements 27a extend in multiple directions can be reduced. Accordingly, the rigidity of the connecting part between the connecting wall 19 and the floor fixing part 18 can be kept high while keeping the substantial thickness of the floor fixing part 18 small.

In addition, in the vehicle body front structure of the embodiment, the lower rib 27 disposed in the region adjacent to the end portion of the floor fixing part 18 in the vehicle width direction is set such that the extension direction of the rib elements 27a does not face the vehicle width direction. For this reason, when the impact load is input from the side of the vehicle 1, the outer region of the floor fixing part 18 in the vehicle width direction can be smoothly deformed to efficiently absorb the input impact.

The present invention is not limited to the above-mentioned embodiment, and various design changes may be made without departing from the spirit of the present invention. For example, in the above-mentioned embodiment, while only one panel fixing part 23 is provided on the upper portion of each of the connecting walls 19 of the load transfer block 11, a plurality of panel fixing parts 23 may be provided on each of the connecting walls 19.

In addition, in the above-mentioned embodiment, while the damper housing parts 15 are integrally formed with the load transfer block 11, the load transfer block 11 does not necessarily have to be integrally provided with the damper housing parts 15.

In addition, in the case of the above-mentioned embodiment, the load transfer block 11 has the block of the left region to which the left front side frame 10 is fixed and the block of the right region to which the right front side frame 10 is fixed, which are formed integrally with each other. However, the load transfer block may be configured so that the block of the left region and the block of the right region are separate components.

Further, in the above-mentioned embodiment, while the upper extension rib 26 and the lower rib 27 are provided on the floor fixing part 18 of the load transfer block 11, the upper extension rib 26 or the lower rib 27 does not necessarily have to be provided. In addition, the ribs having the plurality of rib elements extending in multiple directions may be provided on both the upper surface side and the lower surface side of the floor fixing part 18.

### BRIEF DESCRIPTION OF THE REFERENCE SYMBOLS

2 . . . Passenger compartment
10 . . . Front side frames
11 . . . Load transfer block
12 . . . Floor member
13 . . . Dashboard lower panel
17 . . . Frame fixing part
18 . . . Floor fixing part
19 . . . Connecting wall
20 . . . Upper reinforcement rib
23 . . . Panel fixing part
26 . . . Upper extension rib
27 . . . Lower rib
27a. . . Rib element

1-4. (canceled)

5. A vehicle body front structure comprising:
a floor member disposed below a passenger compartment;
front side frames extending forward from positions above the floor member in front of the passenger compartment;
a dashboard lower panel standing forward and upward from a front part of the floor member and configured to cover the front of the passenger compartment; and
a load transfer block that is an integrated casting part configured to connect rear parts of the front side frames and the front part of the floor member,
wherein the load transfer block has:
a frame fixing part to which the rear parts of the front side frames are fixed;
a floor fixing part to which the front part of the floor member is fixed; and
a connecting wall extending substantially along the dashboard lower panel and configured to connect the frame fixing part and the floor fixing part, and
a plurality of upper reinforcement ribs standing upward and extending in a forward/rearward direction are provided on an upper surface side of the connecting wall and spaced apart from each other in a vehicle width direction.

6. The vehicle body front structure according to claim 5, wherein a panel fixing part fixed to the dashboard lower panel above the upper reinforcement rib is provided on the connecting wall.

7. The vehicle body front structure according to claim 5, wherein an upper extension rib continuous with the upper reinforcement rib is provided on the upper surface of the floor fixing part,
a lower rib having a plurality of rib elements protruding downward and extending in multiple directions is provided on a lower surface of the floor fixing part, and
a protrusion height of the upper extension rib is set to be greater than a protrusion height of the lower rib.

8. The vehicle body front structure according to claim 6, wherein an upper extension rib continuous with the upper reinforcement rib is provided on the upper surface of the floor fixing part,
a lower rib having a plurality of rib elements protruding downward and extending in multiple directions is provided on a lower surface of the floor fixing part, and
a protrusion height of the upper extension rib is set to be greater than a protrusion height of the lower rib.

9. The vehicle body front structure according to claim 7, wherein the lower rib disposed in a region adjacent to an end portion of the floor fixing part in the vehicle width direction is set such that an extension direction of the rib element does not match the vehicle width direction.

10. The vehicle body front structure according to claim 8, wherein the lower rib disposed in a region adjacent to an end portion of the floor fixing part in the vehicle width direction is set such that an extension direction of the rib element does not match the vehicle width direction.
